(19) United States
(12) Patent Application Publication
(10) Pub. No.: US 2024/0132004 A1
(43) Pub. Date: Apr. 25, 2024

(54) On-Board Electrical System, and Method for Operating an On-Board Electrical System

(71) Applicant: Bayerische Motoren Werke Aktiengesellschaft, Muenchen (DE)

(72) Inventor: Thomas KLAWITTER, Muenchen (DE)

(21) Appl. No.: 18/277,313

(22) PCT Filed: Feb. 11, 2022
(86) PCT No.: PCT/EP2022/053383

§ 371 Date: Aug. 14, 2023

(30) Foreign Application Priority Data
Feb. 19, 2021 (DE) 10 2021 103 954.1

(51) Int. Cl. B60R 16/03

(52) U.S. Cl. CPC B60R 16/03

(57) ABSTRACT

Described is an on-board electrical system for a vehicle. The on-board electrical system includes a first sub-network having a first energy source and one or more first electrical consumers, a second sub-network having a second energy source and one or more second electrical consumers, and an isolating switching element which is designed to isolate the first sub-network from the second sub-network. The on-board electrical system also includes at least one event-relevant electrical consumer and a changeover switching element which is designed to selectively couple the event-relevant consumer to the first sub-network or to the second sub-network bypassing the isolating switching element.

### BACKGROUND AND SUMMARY OF THE INVENTION

The invention relates to an on-board electrical system for a vehicle. In particular, the invention relates to the efficient and reliable arrangement of electrical loads in an on-board electrical system of a vehicle.

A vehicle comprises at least one on-board electrical system for supplying electrical energy to a plurality of electrical loads in the vehicle. Different electrical loads can assume different requirements for functional security. In particular, the vehicle can comprise one or more electrical loads which are safety-related with respect to the (driving) operation of the vehicle and/or the design rating of which must be compliant with a specific ASIL (Automotive Safety Integrity Level). Moreover, a vehicle typically comprises one or more electrical loads which are not safety-related and/or the provision of which is only required in the interests of QM (Quality Management).

The present document addresses the technical object of the operation of different electrical loads, particularly having different integrity and/or utility requirements, in an efficient and reliable manner within an on-board electrical system.

This object is fulfilled by each of the independent claims. Additional advantageous embodiments are described in the dependent claims. It should be observed that additional features of a patent claim which is dependent upon an independent patent claim, in the absence of the features of the independent patent claim, or in combination with only a proportion of the features of the independent patent claim, can form a standalone invention, which is independent of the combination of all features of the independent patent claim, and which can be the subject matter of an independent claim, a divisional application or a subsequent application. The same applies, in a corresponding manner, to the technical instruction described in the description, which can form an invention which is independent of the features of the independent patent claims.

According to one aspect, an on-board electrical system for a (motor) vehicle is described. The on-board electrical system can assume a nominal voltage, in the low-voltage range, of 60 V or lower, particularly 12 V or 48 V.

The on-board electrical system comprises a first sub-network having a first energy source and having one or more first electrical loads. The first energy source can comprise a DC voltage converter for the supply of electrical energy from another on-board electrical system having a different system voltage and/or a generator for the generation of electrical energy. The first sub-network (particularly the components of the first sub-network) can be designed in accordance with QM (Quality Management) as per ISO 26262 and/or not in accordance with an ASIL (Automotive Safety Integrity Level) A to D, as per ISO 26262.

The on-board electrical system further comprises a second sub-network having a second energy source and having one or more second electrical loads. The second energy source can be an electrical energy store, particularly an electrochemical energy store, for example a lithium-ion battery or a lead-acid accumulator. The second sub-network (particularly the components of the second sub-network) can be designed in accordance with an ASIL A to D, as per ISO 26262.

The on-board electrical system moreover comprises an isolating switching element (e.g., a relay and/or a semiconductor-based switching element) which is designed to isolate the first sub-network from the second sub-network (by the opening of the isolating switching element) or to connect the first sub-network to the second sub-network (in an electrically conductive manner) (where the isolating switching element is closed). The isolating switching element can have a design rating in accordance with an ASIL A to D, as per ISO 26262.

The isolating switching element can be employed for the (galvanic) isolation of the first sub-network (which, in comparison with the second sub-network, can assume relatively low integrity requirements) from the second sub-network (particularly by the opening of the isolating switching element). In an efficient and reliable manner, it can thus be achieved that, upon the occurrence of an event (e.g., a fault or an accident), safe operation of the one or more components of the second sub-network can be maintained (with no potential impairment associated with the first sub-network).

The on-board electrical system further comprises at least one event-relevant electrical load. An event-relevant electrical load can be a load which does not fulfil the safety and/or integrity requirements of the second sub-network, but which (for the provision of a subset of sub-functions of the event-relevant load), upon the occurrence of an opening event (wherein the isolating switching element is opened), is intended to be connected to the second sub-network. The event-relevant load can be designed, e.g., in accordance with QM, as per ISO 26262, and/or not in accordance with an ASIL A to D. An exemplary event-relevant load is a door control unit, which is designed to unlock a vehicle door.

The event-relevant load can be designed to deliver a totality of sub-functions, if the event-relevant load is connected to the first sub-network. The event-relevant load can moreover be designed to deliver only a subset of the totality of sub-functions (which is reduced in relation to the totality thereof), if the event-relevant load is coupled to the second sub-network. Alternatively or additionally, the event-relevant load can be configured such that the event-relevant load assumes a lower electrical energy consumption and/or a lower electric power consumption if the event-relevant load is coupled to the second sub-network than if the event-relevant load is coupled to the first sub-network.

The on-board electrical system further comprises a changeover switching element (e.g., a changeover relay and/or a semiconductor-based switching element) which is designed to selectively couple the event-relevant load (either directly) to the first sub-network or (directly) to the second sub-network, bypassing the isolating switching element and/or without the involvement of the isolating switching element. The changeover switching element can be arranged in parallel with the isolating switching element. The changeover switching element can be designed to selectively couple the event-relevant load (in an electrically conductive manner) (either) to a first node point of the isolating switching element, which is located on the side of the first sub-network, or (in an electrically conductive manner) to a second node point of the isolating switching element, which is located on the side of the second sub-network. The isolating switching element can be designed for the mutual (galvanic) coupling of the first node point and the second node point (if the isolating switching element is closed) or for the mutual (galvanic) isolation thereof (if the isolating switching element is open). The changeover switching element can have a design rating in accordance with an ASIL A to D, as per ISO 26262.

An on-board electrical system is thus described which is designed to couple at least one event-relevant load, bypassing the isolating switching element, either to the first sub-network (in order to permit the normal operation of the event-relevant load with a relatively high energy consumption) or to the second sub-network (such that, upon the occurrence of an opening event (which is not associated with a malfunction in the first sub-network), one or more event-relevant sub-functions of the event-relevant load can be delivered). An event-relevant load having relatively low integrity requirements (particularly having a restriction to QM requirements) can thus be operated within the on-board electrical system in an efficient manner.

The on-board electrical system can be designed such that the changeover switching element, in normal operation and/or if the isolating switching element connects the first sub-network to the second sub-network (in an electrically conductive manner), connects the event-relevant load, particularly without the involvement of the isolating switching element, to the first sub-network (in a direct and electrically conductive manner). Alternatively or additionally, the on-board electrical system can be designed such that the changeover switching element, upon the occurrence of an opening event (which is not associated with a malfunction in the first sub-network) and/or if the isolating switching element (galvanically) isolates the first sub-network from the second sub-network, connects the event-relevant load, particularly without the involvement of the isolating switching element, to the second sub-network (in a direct and electrically conductive manner). A cost- and space-efficient operation of the event-relevant load is thus permitted, particularly on the grounds that the design rating of the isolating switching element can be defined independently of any consideration of the current and/or power consumption of the event-relevant load.

The on-board electrical system can comprise a control unit which is designed, according to a circuit state of the isolating switching element, to selectively couple the changeover switching element, particularly without the involvement of the isolating switching element, to the first sub-network or to the second sub-network. In particular, the control unit can be designed such that the changeover switching element causes the event-relevant load to be coupled to the first sub-network (in a galvanic and/or electrically conductive manner), if the isolating switching element is closed, wherein the first sub-network is thus coupled to the second sub-network (in an electrically conductive manner), and/or such that the changeover switching element causes the event-relevant load to be coupled to the second sub-network (in a galvanic and/or electrically conductive manner), if the isolating switching element is open, wherein the first sub-network is thus (galvanically) isolated from the second sub-network. A cost- and space efficient operation of the event-relevant load can thus be permitted in a particularly reliable manner.

The control unit can be designed to identify the existence of an opening event (particularly an opening event which is not associated with a malfunction in the first sub-network). Exemplary opening events (which are not associated with a malfunction in the first sub-network) include an accident involving the vehicle or a parking state of the vehicle (in which the vehicle is parked). The control unit can further be designed, in response to the opening event detected (particularly in response to an opening event detected which is not associated with a malfunction in the first sub-network), to cause the isolating switching element to open, such that the first sub-network is (galvanically) isolated from the second sub-network, and/or to cause the changeover switching element to (galvanically) isolate the event-relevant load from the first sub-network, and to execute the (galvanic) coupling thereof to the second sub-network.

Secondly, the control unit can be designed, if no opening event is detected and/or is in force, to cause the isolating switching element to close, such that the first sub-network is coupled to the second sub-network (in a galvanic and/or electrically conductive manner), and/or to cause the changeover switching element to connect the event-relevant load, particularly directly, and without the involvement of the isolating switching element, to the first sub-network (in a galvanic and/or electrically conductive manner) and, in particular, to execute only the indirect coupling thereof to the second sub-network (in a galvanic and/or electrically conductive manner).

The control unit can be designed to determine whether the isolating switching element has been opened in response to a fault or in response to a malfunction, particularly in response to a short-circuit, in the first sub-network, and/or whether the isolating switching element has been opened in response to a predefined operating state, particularly in response to a parking state or an accident-affected state of the vehicle (and thus not in response to a malfunction in the first sub-network). The control unit can moreover be designed to cause the changeover switching element to connect the event-relevant load to the second sub-network only in the event that it is specifically determined, or has been determined, that the isolating switching element has not been opened in response to a fault, particularly not on the grounds of a short-circuit, in the first sub-network, and/or that it has been determined that the isolating switching element has been opened in response to a predefined operating state, particularly in response to a parking state or an accident-affected state of the vehicle.

Alternatively or additionally, the control unit can be designed to determine whether an opening event is in force which is not associated with a malfunction in the first sub-network, or whether an opening event is in force which is associated with a malfunction in the first sub-network. In both cases, the isolating switching element can be opened. Secondly, the control unit can be designed to cause and, in particular, only to cause the changeover switching element to disconnect the event-relevant load from the first sub-network and to execute the connection thereof to the second sub-network, if an opening event is in force which is not associated with a malfunction in the first sub-network. The control unit can further be designed to cause the changeover switching element to maintain the connection of the event-relevant load to the first sub-network, and not to execute the connection thereof to the second sub-network, if an opening event is in force which is associated with a malfunction in the first sub-network.

A cost- and space-efficient operation of the event-relevant load can thus be permitted in a particularly reliable manner.

According to a further aspect, a (road) motor vehicle (in particular a passenger car, or a heavy goods vehicle, or a bus, or a motorcycle) is described which comprises the control unit described in the present document and/or the on-board electrical system described in the present document.

According to a further aspect, a method is described for operating an on-board electrical system. The on-board electrical system can be configured in the manner described in the present document. The method comprises determination to the effect that an opening event is in force. In response to such determination, the method comprises the initiation of the opening of the isolating switching element, such that the first sub-network is (galvanically) isolated from the second sub-network, and initiation of the coupling of the event-relevant load to the second sub-network by the changeover switching element (in a galvanic and/or electrically conductive manner).

The method can further comprise determination to the effect that an opening event is in force which is associated with a malfunction in the first sub-network, in particular with a voltage in the first sub-network which lies below a voltage threshold value and/or with a current in the first sub-network which exceeds a current threshold value. In response thereto, the isolating switching element can be caused to open, such that the first sub-network is isolated from the second sub-network, and the changeover switching element can be caused to maintain the coupling of the event-relevant load to the first sub-network.

By means of the distinction between an opening event which is associated with a malfunction in the first sub-network and an opening event which is not associated with a malfunction in the first sub-network, and/or which is associated with a defined (controlled) operating state of the vehicle, the operational reliability of the on-board electrical system can be further enhanced.

According to a further aspect, a software (SW) program is described. The SW program can be designed for running on a processor (e.g., on a control device of a vehicle) in order to execute the method described in the present document.

According to a further aspect, a storage medium is described. The storage medium can comprise a SW program which is designed for running on a processor, in order to execute the method described in the present document.

It should be observed that the methods, devices and systems described in the present document can be employed either in isolation, or in combination with other methods, devices and systems described in the present document. Moreover, any aspects of the methods, devices and systems described in the present document can be mutually combined in a variety of ways. In particular, the features of the claims can be mutually combined in a variety of ways.

The invention is described in greater detail hereinafter with reference to exemplary embodiments. In the figures:

### BRIEF DESCRIPTION OF THE DRAWINGS

FIG. 1a shows an exemplary on-board electrical system for a vehicle, having a plurality of sub-networks;

FIG. 1b shows the on-board electrical system according to FIG. 1a, with an event-relevant electrical load;

FIG. 2 shows an on-board electrical system having a changeover switching element; and

FIG. 3 shows a flow diagram of an exemplary method for operating an on-board electrical system.

### DETAILED DESCRIPTION OF THE DRAWINGS

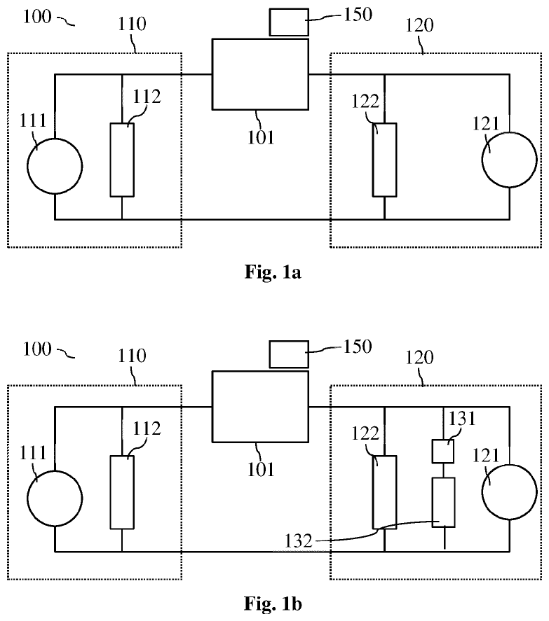

As described above, the present document addresses the efficient operation of various electrical loads in a vehicle. In this connection, FIG. 1a shows an exemplary on-board electrical system 100 for supplying electrical loads of a vehicle. The on-board electrical system 100 is designed to supply electrical energy to electrical loads 112, 122 having different safety and/or integrity requirements. Exemplary loads 112, 122 are as follows:
a safety-related load 122 which, for example, fulfils or is required to fulfil specific integrity requirements, particularly a specific ASIL; and
a non-safety-related load 112, which is not required to fulfil any specific integrity requirements and/or, for example, is only designed, or is only required to be designed in accordance with QM.

In order to prevent any impairment of the operation of a safety-related load 122 as a result of a fault in a non-safety-related load 112, the on-board electrical system 100 can comprise a plurality of sub-networks 110, 120 for loads 112, 122 having different safety and/or integrity requirements. In particular, the on-board electrical system 100 can comprise a first sub-network 110 for one or more non-safety-related (first) loads 112, and a second sub-network 120 for one or more safety-related (second) loads 122.

Each of the sub-networks 110, 120 can comprise a dedicated energy source 111, 121 (e.g., an electrochemical energy store and/or a voltage converter), which is designed for the supply of electrical energy in the respective sub-network 110, 120. In particular, the first sub-network 110 can comprise a first energy source 111 (e.g., a voltage converter, which is designed to supply electrical energy from a further on-board electrical system) and the second sub-network 120 can comprise a second energy source 121 (e.g., an energy store). The first energy source 111 can be configured to deliver a higher quantity of electrical energy and/or a higher electric power than the second energy source 121.

The two sub-networks 110, 120 can be mutually connected, in an electrically conductive manner, by means of an isolating element or isolating switching element 101, e.g., by means of a relay and/or by means of a semiconductor-based switching element. It can thus be permitted, in the normal operation of the on-board electrical system 100, that the second energy source 121 is charged by means of the first sub-network 110, and/or that the one or more loads 122 on the second sub-network 120 is/are supplied with electrical energy from the first sub-network 110.

Secondly, in the event of the occurrence of a specific event (e.g., in the event of an accident), the control unit 150 can cause, for example, the isolating element 101 to open, such that any influence of the first sub-network 110 upon the one or more safety-related (second) loads 122 on the second sub-network 120 is prevented.

The on-board electrical system 100 can thus be configured, for safety-related driving functions such as, for example, steering, braking, lighting and/or windshield wiping, to deliver a secure supply of electrical energy such that, even further to the occurrence of a fault (for example, further to a fault in the energy supply), electrical energy will continue to be available to the one or more safety-related loads 122. This can be achieved by means of an on-board electrical system architecture wherein, by means of an isolating switch 101, a second on-board sub-network 120 having a functional security qualification can be separated from a first on-board sub-network 110 having a QM qualification.

Each of these on-board sub-networks 110, 120 typically comprises a power distribution system in the form of one or more (optionally electronic) distribution boards, which execute the further branching and distribution of the respective integrity delivered (QM or ASIL). For reasons of cost, it is typically advantageous that the ASIL-qualified second on-board sub-network 120, which comprises the one or more ASIL-rated components 121, is electrically connected to a battery 122, such that it is only necessary for the generator 111 in the first sub-network 110 (e.g., a converter for the supply of electrical energy from a 48 V or HV (high-voltage) on-board electrical system) to be rated for QM purposes, and to supply electrical energy to the QM-qualified first sub-network 110, having one or more QM-rated components 112.

Via the (closed) isolating element 101, in normal operation, compensating currents typically flow for the supply of the one or more loads 122 in the second sub-network 120. Optionally, for the charging of the battery 121 in the second sub-network 120 and/or for the fulfilment of short-term demand, relatively large currents can flow via the isolating element 101.

A vehicle can comprise one or more electrical loads which, although having no requirement for a secure energy supply, must nevertheless be supplied by the energy source 121 on the second sub-network 120 such that, even if the isolating switch 101 is open (e.g., under stationary conditions or further to an accident), they can continue to deliver their respective function (at least in part). One example of a load of this type is a door control unit, which should be capable, or is required to be capable of unlocking a vehicle door, even after an accident.

In the present document, a load which is not subject to any particular safety and/or integrity requirements for energy supply (and which, for example, is only required to fulfil QM requirements) but which, further to an opening event, wherein the isolating element 101 has been opened, should, or is required to be supplied with electrical energy within the second sub-network 120, is described as an event-relevant load.

FIG. 1b shows an on-board electrical system 100 having an exemplary event-relevant load 132, which is connected via a second isolating element 131 to the second sub-network. The second isolating element 131 fulfils the safety and/or integrity requirements (e.g. a specific ASIL) of the second sub-network 120. It is thus permitted for a QM load 132 to be connected to the second sub-network 120 in a secure manner.

However, the architecture represented in FIG. 1b is such that, in normal operation, electric power for the event-relevant load 132 is routed via the first isolating element 101, such that it is necessary for the first isolating element 101 to be rated with a corresponding performance capability. In particular, this can then be associated with a relatively high degree of complexity, if the event-relevant load 132, in addition to a sub-function which, upon the occurrence of an opening event, is intended to be available (such as the unlocking of a door), assumes a further sub-function which is not relevant to the opening event and is associated with a relatively high power demand (such as a heating function for an armrest of a door). It will then be necessary for the first isolating element 101 to be rated for the power demand of all the sub-functions of the event-relevant load 132.

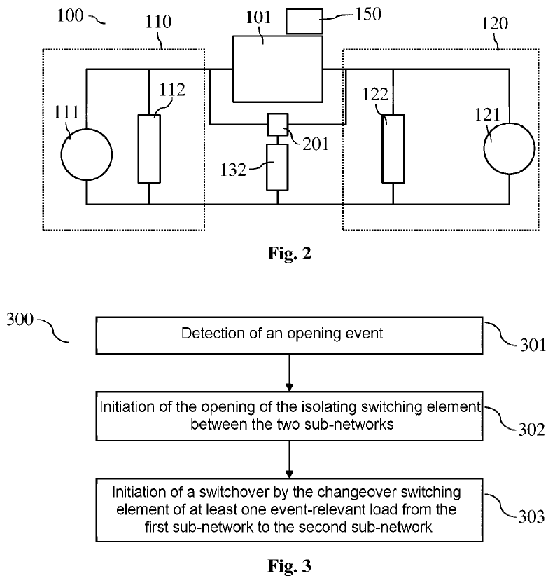

FIG. 2 shows an on-board electrical system 100 having an event-relevant load 132 which can optionally be connected by means of a changeover element (particularly by means of a changeover switching element) 201 either to the first sub-network 110 or to the second sub-network 120. The changeover element 201 is thus arranged in parallel with the (first) isolating element 101, such that it is not necessary for electrical energy for the supply of the event-relevant load 132 to be routed via the (first) isolating element 101.

The control unit 150 of the on-board electrical system 100 can be designed to cause the event-relevant load 132, in normal operation, to be connected via the changeover element 201 to the first sub-network 110, such that electrical energy for the operation of the event-relevant load 132 (optionally, in an exclusive and/or direct manner) is sourced from the first sub-network 110.

The control unit 150 can moreover be designed, in response to the detection of an opening event, wherein the isolating element 101 is opened, to isolate the second sub-network 120 from the first sub-network 110, wherein the changeover element 201 is caused to couple the event-relevant load 132 to the second sub-network 120 (and thus to execute the isolation thereof from the first sub-network 110). It can thus be achieved, in an efficient manner, that the event-relevant load 132, upon the occurrence of an opening event (e.g., further to an accident), is securely supplied (optionally, in an exclusive and/or direct manner) with electrical energy from the second sub-network 120, in order to permit the delivery of the event-relevant sub-function of the event-relevant load 132.

An on-board electrical system 100 is thus described, wherein one or more components 132, in respect of which no safety requirements apply on the on-board electrical system (e.g., which are only rated for the purposes of QM) but which, in one or more states, in which the isolating element 101 is open, are required to be supplied from the battery side and/or from the second sub-network 120, are subject to load-demand control by means of a changeover relay 201 (in general by means of a changeover element) and are dynamically assigned to the converter side or the first sub-network 110, or to the battery side or the second sub-network 120.

It is thus possible for one or more components 132 which, under normal circumstances (e.g., where the vehicle is active, for example during an “occupied” or “driving” state), are supplied in the first sub-network 110 via the changeover element 201, to be supplied by means of the generator 111 (e.g. by means of a DC voltage converter or alternator), and to be assigned by means of the changeover element 201, only if necessary (e.g., during a “parking” or “crash” state), to the second sub-network 120 having the power source 121. In these particular cases (parking or crash states), the one or more event-relevant components 132 typically assume a lower power demand than under normal circumstances. The on-board electrical system architecture represented in FIG. 2 permits the isolating element 101 to be dimensioned with a relatively low rating, and thus in a cost- and space-efficient manner.

As indicated above, a door control unit (e.g., for the front and rear right-side doors) is one example of an event-relevant load 132. The door control unit can assume a relatively high maximum current consumption which, e.g., via the door control unit, can also be supplied to armrest heaters in the doors (e.g., with a respective rating of 15 A). As this heating system represents a continuous load, the isolating element 101, in the absence of the employment of a changeover switch 201, would need to be configured with a correspondingly high rating and/or performance capability, given the necessity for these continuous currents to be routed via the isolating element 101 (as represented in FIG. 1b).

The door control unit is typically a post-crash-relevant component, and must therefore be located on the battery side (i.e., in the second sub-network 120), in order to permit the execution of the “door unlocking” function further to a crash. Conversely, further to a crash, the armrest heating function is no longer required. In the event of the employment of a changeover switch 201, it is possible for high continuous currents to be maintained directly in the converter-side first sub-network 110, and not to be routed via the main isolating switch 101.

FIG. 3 shows a flow diagram of an exemplary (optionally computer-implemented) method 300 for operating an on-board electrical system 100. The method 300 can be executed by means of a control unit 150 of the on-board electrical system 100 and/or of a vehicle. The on-board electrical system 100 comprises a first sub-network 110 having a first energy source 111 and/or having one or more first electrical loads 112. The first sub-network 110 can be designed, e.g., in accordance with QM only and/or not in accordance with a specific ASIL.

The on-board electrical system 100 further comprises a second sub-network 120 having a second energy source 121 (e.g., an energy store) and/or having one or more second electrical loads 122. The second sub-network 120 can be designed, e.g., in accordance with a specific ASIL. The on-board electrical system 100 moreover comprises an isolating switching element 101, which is designed to isolate the first sub-network 110 from the second sub-network 120. The isolating switching element 101 can be rated in accordance with the specific ASIL.

The on-board electrical system 100 further comprises at least one event-relevant electrical load 132 (which is designed, e.g., in accordance with QM only and/or not in accordance with the specific ASIL), and a changeover switching element 201, which is designed to selectively couple the event-relevant load 132 to the first sub-network 110 or to the second sub-network 120, bypassing the isolating switching element 101 and/or without the involvement of the isolating switching element 101. The changeover switching element 201 can be rated in accordance with the specific ASIL.

The method 300 comprises determination 301 to the effect that an opening event (e.g., an accident or a parking state of the vehicle) is in force. The opening event can be detected, e.g., on the basis of a signal on a data bus of the vehicle.

The method 300 further comprises, in response to the determination step 301, initiation 302 of the opening of the isolating switching element 101, in order to (galvanically) isolate the first sub-network 110 from the second sub-network 120, and initiation 303 of the connection by the changeover switching element 201 of the event-relevant load 132 to the second sub-network 120. An on-board electrical system 100 can thus be provided and operated in a cost- and space-efficient manner.

In particular, in the context of the method 300, it can be determined (in step 301) that an opening event is in force which is not associated with a fault (e.g., an overvoltage, an overload and/or a short-circuit) in the first sub-network 110. The switchover of the event-relevant load 132 from the first sub-network 110 to the second sub-network 120 by the changeover switching element 201 (in step 303) can then, optionally, only be executed if an opening event is in force which is not associated with a fault in the first sub-network 110. Optionally, a switchover can only be executed in the event of fault-free operation of the on-board electrical system 100, particularly of the first sub-network 110. It can thus be prevented, in a reliable manner, that the event-relevant load 132 which, optionally, is the cause of a fault in the first sub-network 110, causes a fault in the second sub-network 120. It can thus be prevented, in a reliable manner, that the integrity of the second sub-network 120 is compromised by the event-relevant load 132.

The present invention is not limited to the exemplary embodiments represented. In particular, it should be observed that the description and the figures are only provided by way of an exemplary illustration of the method, devices and systems proposed.

1.-15. (canceled)

16. An on-board electrical system for a vehicle, the on-board electrical system comprising:
a first sub-network having a first energy source and one or more first electrical loads;
a second sub-network having a second energy source and one or more second electrical loads;
an isolating switching element configured to isolate the first sub-network from the second sub-network;
at least one event-relevant electrical load; and
a changeover switching element configured to selectively couple the event-relevant load to the first sub-network or to the second sub-network, bypassing the isolating switching element.

17. The on-board electrical system according to claim 16, wherein the on-board electrical system is configured such that:
the changeover switching element, in normal operation and/or in a case in which the isolating switching element connects the first sub-network to the second sub-network, connects the event-relevant load, without involvement of the isolating switching element, to the first sub-network; and
the changeover switching element, upon the occurrence of an opening event and/or the isolating switching element isolating the first sub-network from the second sub-network, connects the event-relevant load, without the involvement of the isolating switching element, to the second sub-network.

18. The on-board electrical system according to claim 16, wherein the on-board electrical system comprises a control unit configured to selectively couple the changeover switching element to the first sub-network or to the second sub-network, based on a circuit state of the isolating switching element, without involvement of the isolating switching element.

19. The on-board electrical system according to claim 18, wherein the control unit is configured such that:
the changeover switching element causes the event-relevant load to be coupled to the first sub-network, in a case in which the isolating switching element is closed, wherein the first sub-network is thus coupled to the second sub-network, and/or
the changeover switching element causes the event-relevant load to be coupled to the second sub-network, in a case in which the isolating switching element is open, wherein the first sub-network is thus isolated from the second sub-network.

20. The on-board electrical system according to claim 19,
wherein the control unit is configured to determine:
whether the isolating switching element has been opened in response to a fault, in response to a short-circuit, in the first sub-network, and/or
whether the isolating switching element has been opened in response to a predefined operating state including a parking state or an accident-affected state of the vehicle; and
wherein the changeover switching element only causes the event-relevant load to be coupled to the second sub-network in a case in which it is determined that:
the isolating switching element has not been opened in response to a fault, including a short-circuit, in the first sub-network, and/or
the isolating switching element has been opened in response to a predefined operating state, including a parking state or an accident-affected state of the vehicle.

21. The on-board electrical system according to claim 16, wherein the on-board electrical system comprises a control unit configured to determine that an opening event is in force, and in response thereto:
to cause the isolating switching element to open, such that the first sub-network is isolated from the second sub-network; and
to cause the changeover switching element to isolate the event-relevant load from the first sub-network, and to execute the coupling thereof to the second sub-network.

22. The on-board electrical system according to claim 21, wherein the control unit is configured to:
determine whether an opening event is in force which is not associated with a malfunction in the first sub-network; and
cause only the changeover switching element to disconnect the event-relevant load from the first sub-network and to execute the connection thereof to the second sub-network, in a case in which an opening event is in force which is not associated with a malfunction in the first sub-network; and/or
cause the changeover switching element to maintain the coupling of the event-relevant load to the first sub-network, and not to execute the connection thereof to the second sub-network, in a case in which an opening event is in force which is associated with a malfunction in the first sub-network.

23. The on-board electrical system according to claim 21, wherein the opening event in an absence of a malfunction in the first sub-network comprises an accident involving the vehicle and/or a parking state of the vehicle.

24. The on-board electrical system according to claim 21, wherein the control unit is configured to, in a case in which no opening event is detected and/or is in force:
cause the isolating switching element to close, such that the first sub-network is coupled to the second sub-network; and
cause the changeover switching element to connect the event-relevant load directly, without the involvement of the isolating switching element, to the first sub-network and to execute only the indirect coupling thereof to the second sub-network.

25. The on-board electrical system according to claim 16, wherein:
the second sub-network is designed in accordance with an ASIL, as per ISO 26262; and/or
the first sub-network is designed in accordance with QM, as per ISO 26262, and/or not in accordance with an ASIL;
the isolating switching element and/or the changeover switching element are designed in accordance with an ASIL, as per ISO 26262; and/or
the event-relevant load is designed in accordance with QM, as per ISO 26262, and/or not in accordance with an ASIL.

26. The on-board electrical system according to claim 16, wherein:
the isolating switching element comprises a relay and/or a semiconductor-based switching element; and/or
the changeover switching element comprises a changeover relay and/or a semiconductor-based switching element.

27. The on-board electrical system according to claim 16, wherein:
the event-relevant load is configured to deliver a totality of sub-functions, in a case in which the event-relevant load is connected to the first sub-network, and to deliver only a subset of the totality of sub-functions, in a case in which the event-relevant load is coupled to the second sub-network; and/or
the event-relevant load is configured such that the event-relevant load assumes a lower electrical energy consumption and/or a lower electric power consumption when the event-relevant load is coupled to the second sub-network than when the event-relevant load is coupled to the first sub-network.

28. The on-board electrical system according to claim 16, wherein:
the on-board electrical system assumes a nominal voltage, in the low-voltage range, of 12 V or 48 V; and/or
the first energy source comprises a DC voltage converter for the supply of electrical energy from another on-board electrical system having a different system voltage and/or a generator for the generation of electrical energy; and/or
the second energy source comprises an electrochemical energy store.

29. A method for operating an on-board electrical system, which includes the following:
a first sub-network having a first energy source and one or more first electrical loads;
a second sub-network having a second energy source and one or more second electrical loads;
an isolating switching element configured to isolate the first sub-network from the second sub-network;
at least one event-relevant electrical load; and
a changeover switching element configured to selectively couple the event-relevant load to the first sub-network or to the second sub-network, bypassing the isolating switching element;
the method comprising:
determining that an opening event is in force that is not associated with a malfunction in the first sub-network;
in response to determining that the opening event is in force that is not associated with the malfunction, initiating the opening of the isolating switching element, such that the first sub-network is isolated from the second sub-network; and
in response to determining that the opening event is in force that is not associated with the malfunction, initiating the coupling of the event-relevant load to the second sub-network by the changeover switching element.

30. The method according to claim 29, further comprising:
determining that an opening event is in force which is associated with the malfunction in the first sub-network, the malfunction including a voltage in the first sub-network which lies below a threshold voltage value, and/or a current in the first sub-network which exceeds a current threshold value; and
in response to determining that the opening event is in force which is associated with the malfunction in the first sub-network, initiating the opening of the isolating switching element, such that the first sub-network is isolated from the second sub-network, and initiating the maintenance by the changeover switching element of the connection of the event-relevant load to the first sub-network.
